(19) United States
(12) Patent Application Publication
(10) Pub. No.: US 2007/0094072 A1
(43) Pub. Date: Apr. 26, 2007

(54) Apparatus and method of identifying critical factors in a pay-for-performance advertising network

(75) Inventors: Guillermo V. Vidals, Escondido, CA (US); David G. Johnson, Escondido, CA (US)

Correspondence Address: JERRY RICHARD POTTS, 3248 VIA RIBERA, ESCONDIDO, CA, 92029, US

(73) Assignee: Etica Entertainment, Inc., DBA Position Research, Escondido, CA (US)

(21) Appl. No.: 11/258,981

(22) Filed: Oct. 26, 2005

(51) Int. Cl. G06Q 30/00

(52) U.S. Cl. 705/14

(57) ABSTRACT

An apparatus and method for improving the performance of an Internet website includes a performance processor that identifies a plurality of critical performance factors that facilitate improved website performance and then tests in real time, by utilization of an application programming interface, the influence of individual ones of said plurality of performance factors by application of a fractional factorial design.

### BACKGROUND OF PRIOR ART

In the early days of internet advertising, the internet advertising revenue model was similar to that utilized by the traditional print-ad model, where pricing was based on a fixed cost per impression. More impressions meant more revenue.

Studies in the early internet advertising found that click-through rates of traditional internet banner advertising were much more effective when placed on web pages that were contextually sensitive. This insight helped move the market toward a pay-per-click revenue model.

In June of 1998, an internet advertiser known as Overture (formerly goto.com) introduced a new advertising scheme designed to work with search engine results. By 2001 Overture had extended its reach by offering its services to major search engines, including Yahoo and MSN.

Today, most if not all major search engines are offering Pay-Per-Action (PPA), also referred to as pay-for-performance, advertising models. Overture, now a Yahoo company, serves Yahoo.com and MSN.com (MSN.com is expected to launch their own version in 2005). Google offers their own service called AdWords.

The PPA model has expanded to include several “call-to-actions” venues that include the following for example: Pay-Per-Click (PPC); Pay-Per-Call; Pay-Per-Lead; Pay-Per-Sale; and Pay-Per-Read. With reference to the venues, the most prominent models are PPC and, most recently, Pay-Per-Call. Other affiliate networks like Commission Junction offer the full range of PPA venues.

During the evolution of PPA advertising, several third party vendors developed value added services that help subscribers maximize Return On Investment (ROI) by focusing on two primary tasks; namely bid gap management and click fraud identification and reporting. Prominent players in this market include for example: BidBuddy; BidGuard; BidRank; Dynamic Keyword Bid Maximizer; Keyword Max; Maestro; one point; ppc BidTracker; ppc Pro; and Traffic Patrol.

Although these services do add real value and cost justify their additional expense, none currently offer optimization or testing of the creative advertisement or other variables that influence campaign performance. More importantly, none offer the identification of critical factors in a pay-for-performance advertising network.

Therefore it would be highly desirable to have a new and improved method and apparatus for identifying in real time critical advertising factors in a pay-for-performance advertising network.

### BRIEF SUMMARY OF THE INVENTION

An apparatus and method for improving the performance of an Internet web page includes a performance processor that identifies a plurality of critical performance factors that facilitate improved web page performance and then tests in real time, by utilization of an application programming interface, the influence of individual ones of said plurality of performance factors by application of a fractional factorial design of experiments.

### BRIEF DESCRIPTION OF THE DRAWINGS

The above mentioned features and steps of the invention and the manner of attaining them will become apparent, and the invention itself will be best understood by reference to the following description of the preferred embodiment(s) of the invention in conjunction with the accompanying drawings wherein:

FIG. 1 is a diagrammatic illustration of a critical factor pay-for-performance computer system, which is constructed in accordance with an embodiment of the present invention;

FIG. 2 is a set of flowcharts for identifying critical factors in a pay-for-performance advertising network, which method is in accordance with a preferred embodiment of the present invention;

FIG. 3 is a diagram of a typical sales funnel describing the influence of different digital advertising factors at different parts of a call-to-action process;

FIG. 4 is a chart of typical design of experiment layout employing a mixed level, such as L18B, inner orthogonal array;

FIG. 5 is a diagram of a design of experiment process showing control factors and noise factors;

FIG. 6 is a diagram of a typical design of experiment layout employing a mixed level, L18B, inner orthogonal array and L4 outer orthogonal array;

FIG. 7 is an example printout of search engine results illustrating sponsored links as digital advertisements;

FIG. 8 is an identification table illustrating main effect and noise factors included in a design of experiment case study example;

FIG. 9 is a primary effect factor table illustrating a list of main effect factors and their respective levels for an inner array;

FIG. 10 is a table of measurable noise factors and their respective levels for an outer array;

FIG. 11 is an example of factor-levels for a specified test run, such as a case study test run number 1;

FIG. 12 is a test run factor table for an L18B inner array;

FIG. 13 is a test run noise factor table for an L4 outer array;

FIG. 14 is a test run control factor table for an L18B inner array and L4 outer array;

FIG. 15 illustrates a case study process where a number of repetitions are tracked using an input indicative of the number of digital advertising impressions and an output indicative of the number of click-throughs;

FIG. 16 illustrates a case study process where a number of repetitions are tracked using an input indicative of the number of digital advertising impressions and an output indicative of the number of call-to-action objective;

FIG. 17 illustrates a case study process where a number of repetitions are tracked using an input indicative of the cost for digital advertising impressions and an output indicative of the value of call-to-action profit;

FIGS. 18-20 are conversion charts of FIGS. 15-17 that facilitate analysis of DOE results;

FIG. 21 is a summary table for FIGS. 18-20 illustrating minimum, maximum and mean values;

FIG. 22 is a response table for means, title, rank and keyword types;

FIG. 23 is an ANOVA calculations table for signal to noise ratios versus title, rank and keyword types;

FIG. 24 is an ANOVA calculations table for means versus title, rank and keyword types;

FIG. 25 is a predicted value table for the analysis of title, rank and keyword types;

FIG. 26 is a computation table of confidence intervals for different confidence levels;

FIG. 27 is a summary table of the most influential factor-levels predicted relative to title, rank and keyword types;

FIG. 28 is a response table for means, title, landing page, and region;

FIG. 29 is an ANOVA calculations table for signal to noise ratios versus title, landing page, and region;

FIG. 30 is an ANOVA calculations table for means versus title, landing page and region;

FIG. 31 is a predicted value table for the analysis of title, landing page and region of FIGS. 28-30;

FIG. 32 is a summary table of the most influential factor-levels predicted;

FIG. 33 is a response table for means, landing page, time of day and region;

FIG. 34 is an ANOVA calculations table for signal to noise ratios versus landing page, time of day, and region;

FIG. 35 is an ANOVA calculations table for means versus landing page, time of day, and region;

FIG. 36 is a predicted value table for the analysis of landing page, time of day and region of FIGS. 33-35;

FIG. 37 is a summary table of the most influential factor-levels predicted relative to landing page, time of day and region;

FIG. 38 is a summary table of test with confirmation test runs; and

FIG. 39 is a summary table of tests and most influential factor-level predicted.

### DETAILED DESCRIPTION OF THE PREFERRED EMBODIMENTS OF THE INVENTION

An apparatus and method for improving the performance of an Internet web page is disclosed. The following description is presented to enable any person skilled in the art to make and use the invention. For purposes of explanation, specific nomenclature is set forth to provide a thorough understanding of the present invention. Descriptions of specific applications and methods are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and steps disclosed herein.

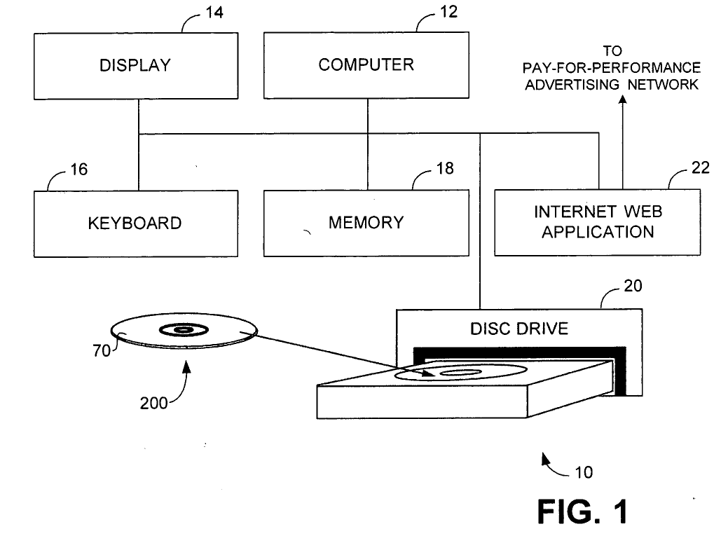

Referring now to the drawings and more particularly to FIGS. 1-3, there is illustrated a web page performance apparatus or processor system 10 and method 200 for improving the performance of an Internet web page, which are constructed in accordance with a preferred embodiment of the present invention. The apparatus 10 implements several different and unique methods for improving the performance of an Internet web page. For example, in one preferred embodiment, the performance apparatus or system 10 and method 200 as applied to a pay-for-performance advertising network improves the performance of a web page advertisement in the pay-for-performance advertising network. As will be explained hereinafter in greater detail, the method 200 for improving web page performance, such as the web page advertising performance is provided on a computer program product 70, which is a computer usable medium that has encoded thereon computer readable codes. The computer readable codes enable a user, via the system 10, to apply the method 200 via an internet web application, such as the web internet application 22 utilizing an application programming interface (not shown) to affect rapid changing of the critical advertising factors in real time. In this regard, the computer readable code causes the computer system 10 to take the following actions:
1) to identify a plurality of critical advertising factors that facilitate improved advertising performance for advertisements similar to a target advertisement in a pay-for-performance network; and
2) to test the influence of individual ones of the plurality of critical advertising factors that facilitate improved advertising performance in the pay-for-performance advertising network by application of a fractional factorial design.

The computer readable code further causes the computer system 10 to take the following additional actions:

3) to implement relative to the target advertisement, identified individual ones of the plurality of critical advertising factors into the pay-for-performance advertising network when there is a test verified improvement provided by the identified individual critical advertising factor.

When there is no improvement in the performance of the target advertisement, the computer readable code then causes the computer system 10 to take the following actions:

4) to predict which individual ones of the plurality of critical advertising factors will improve the advertising performance of the target advertisement in the pay-for-performance advertising network; and

5) to update in real time, the plurality of critical advertising factors so the steps of testing and implementing and predicting can be repeated accordingly.

Before discussing the preferred embodiment of the present invention in greater detail, it should be noted that the apparatus and method of the present invention may be applied in many different ways to improve the performance of an Internet web page. In the preferred embodiment, the apparatus and method will be described relative to improving the performance of a web page advertising layout which is applicable to pay-for-performance advertising. The description that follows however is only illustrative of the application of the invention and is not intended to be a limitation on the various modifications and applications that may be derived from the disclosure that follows.

In the early days of internet advertising, most website owners utilized a revenue model that was similar to that of traditional print-advertising, where advertising pricing was based on a fixed cost per impression. In this regard, in the print-advertising world, the more impressions, the greater the revenue for the website owners.

Studies in the early part of the 1990's found that click-through rates of traditional internet banner advertising was much more effective when placed on web page that were contextually sensitive. This insight helped move the internet advertising marketing community toward what became commonly called a “Pay-Per-Click” revenue model. For example, in June of 1998, a then popular website called “Overture” introduced a new advertising scheme designed (see U.S. Pat. No. 6,269,361) to work with search engine results. By 2001, Overture had extended its reach by offering it services to many of the then major search engines, including Yahoo and MSN.

Today, most if not all of the major search engines are offering “Pay-Per-Action” advertising models. This type of advertising model will be called herein after a PPA model. Overture, now a Yahoo company, serves both Yahoo and MSN, while Google another popular search engine offers its own service called “AdWords”.

The PPA model as described earlier has expanded to include several “call-to-action” venues that include” Pay-Per-Click (PPC); Pay-Per-Call; Pay-Per-Lead; Pay-Per-Sale; and Pay-Per-Read. Within this group, the most prominent models are PPC and most recently, Pay-Per-Call. Other affiliate networks like Commission Junction offer the full range of PPA venues.

During the evolution of PPA advertising, several third party vendors developed value added services that helped subscribers maximize their return on investment (ROI) by focusing on two primary tasks: bid gap management; and click fraud identification and reporting. This group of third party vendors included: Bid Buddy, Bid Guard, Bid Rank; Dynamic Keyword Bid Maximizer, Keyword Max, Maestro, One Point, ppc Bid Tracker, ppc Pro, and Traffic Patrol. Although the services offered by such third party vendors do add real value and cost justify their additional expense, none currently offer optimization or testing of the creative advertisement or other variables that influence campaign performance. The reason why testing and optimization are important will now be explained.

Testing seeks to optimize all aspects of a PPA campaign for a specific objective. That objective may be, for example, to optimize: the number of clicks (click-throughs); the number of purchases; return on investment, and other similar objectives.

Examples of variables or factors that may influence PPA performance are illustrated in Table I:

TABLE I
Typical Variables or Factors Affect Digital Advertising Performance

| | Other Influencing Factors | | |
|---|---|---|---|
| Visible Creative | | | |
| Title | Keyword | Network | Language |
| Description 1 | Landing Page | Time of Day | Demographic |
| Description2 | Rank (price) | Day of Week | Psychographic |
| URL | Keyword match | Region | Graphic |
| | type | | |

It should be noted that such variables may have several distinctively different levels. For example:

1) testing may include three distinctively different rankings (1^{st}, 3^{rd}, and 6^{th}) that influence the position of an advertisement on a website page;

2) testing may include distinctly different times of the day (morning, afternoon, and evening) to determine a best purchase time;

3) testing may include distinctively different titles, such as “love your dog”, “don't hate your dog”, and “your dog needs you” to determine what message expressed in the title produces the greatest number of sales.

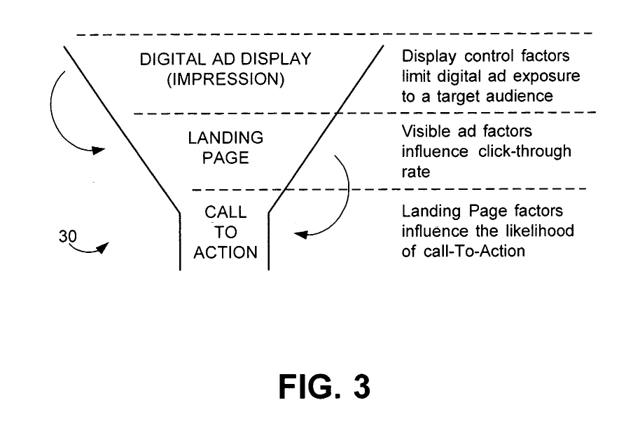

FIG. 3, which is indicative of a “sales funnel” 30 for a call-to-action process; i.e. the process by which a sales or call-to-action objective is made, is instructive of the affect of different advertising factors. The top of the funnel considers the volume of persons exposed to a digital advertisement. Factors such as “the time of day”, “day-of-the-week”, or “region”, for example, affect to whom the digital advertisement is shown. Those that view the advertisement are then affected or influenced by how the advertisement itself is crafted. In this regard, the advertisement may have graphics, headlines or a body message (description) that affects the likelihood of the viewer clicking the link (known as a click-through) to go to a “landing page”, a website page to which a viewer is forwarded upon clicking a link. Influencing factors on the landing page affect the likelihood of the viewer taking the next step—a call-to-action. It should be noted that a viewer's click-through may, in of itself, be considered a call-to-action objective. However, for the purposes of this explanation, call-to-action objective refers to the advertisers final intent (e.g. sale, form, fill, file download, call, read, etc.) and is referred here after as simply call-to-action.

The entire sales funnel as illustrated in FIG. 3, must be considered as a complete process. Factors that may be primary influencers for a “click-through” may not be the same factors that strongly influence a “call-to-action”. In other words, the title and position of a digital advertisement may be the strongest factor influencing a click-through, but regions of the country and the landing page may have more overall influence of the entire process. Furthermore, the best factors affecting unit sales may be different than dollar sales or profits.

As the PPA market matures, the number of influencing factors is likely to increase, making testing tools more and more important. In this regard, testing has the potential of offering the most significant return on investment gains. Depending upon the keyword market, bid gap management saves users typically from ten to thirty percent. Click fraud management can save users another ten to thirty percent. But testing can improve ROI by much greater percentages. In this regard, limited experiments have shown improvements from 20% to 200%, and in some isolated cases, the increase for a specific keyword has exceeded 10 times.

In the current state of the art, there are at least three testing methods known to those skilled in the art. These testing methods include, for example: A/B testing, full factorial testing, and partial factorial testing. Each of these testing methods will now be briefly considered.

A/B testing is the oldest and easiest method. A/B testing involves testing a single variable for a period of time; then observing results. A simple example of A/B testing would be a modification or change to the title of a digital advertisement. After a period of time, results with the new title are observed to be either positive or negative contributions to campaign objectives. Since one variable is changed at a time in order to isolate a contributing factor it does not consider the interactions of one advertising variable on another. In short, A/B testing is very restrictive and only applies to experiments with very few variables.

Full factorial testing is an extension of A/B testing. In this regard, full factorial testing involves testing all combinations of variables, each for a period of time; then observing and comparing results of each combination. The number of experiments or test runs, however, can quickly become impractical as the number of variables and levels increases. For example, consider a small campaign test condition consisting of three variables with three levels of each variable. The number of experiments is computed as 3 to the 3^{rd} power (3³=27).

Likewise, a campaign test consisting of seven variables with three levels of each variable would require 3⁷=2,187 experiments. A campaign test of fifteen variables with two levels each would require 2¹⁵=32,768 experiments. The typical test scenario for PPA campaigns would require between 5,000 and 25,000 test runs.

If each experimental run were to require 30 data samples, a typical experiment for PPA would require a minimum of 5,000×30=150,000 data points. These large values would require extensive time (for example, in the order of months to gather a sufficient number of data points) and resources, making such experiments impractical.

Partial factorial testing, as the name implies, models the results of full factorial testing with a few, carefully crafted experimental runs known as “design of experiments” (DOE). Orthogonal Arrays (OA) are often used to facilitate such a testing method and in the development of the DOE. In most cases, a partial factorial test can be conducted with fewer than twenty experimental runs to model a full factorial test that would ordinarily require 5,000 experiments (e.g. 20 experiments×30 data samples=600 data points). Therefore, partial factorial testing is practical for PPA campaigns.

Since partial factorial testing with Orthogonal Arrays does not test for every possible combination, results of partial factorial testing can only predict what combination of variables (factors) and levels are the main contributors (the main effects) and how much improvement may be expected. Confirmation testing is necessary to validate these predictions.

Partial factorial testing has been used in the engineering community since the mid nineteen hundreds and has proven to be an invaluable tool for design engineers. However, engineering experiments classically contain factors that do not influence each other. For example, consider the design of a camshaft. The angle of attack and material hardness are 2 factors that do not influence each other. Partial factorial testing is ideal for such independent factor conditions.

There are, however, engineering designs that do have factors that affect one another. Consider a design that desires to optimize human comfort in an office space for example. Temperature and humidity are two factors that have influence on one another and are said to interact with one another. In this regard, as humidity rises, temperature must decline to maintain the same level of comfort. In such cases, where factors interact with one another, most orthogonal arrays must be applied in consideration of the interactions.

Most, if not all factors involved in sales and marketing evaluations do influence each other but are very difficult to isolate. The title of a PPA campaign does influence the reaction of the viewer to the description, as does the choice of keyword and whether it is a broad or exact match. Even the time of day and/or the region of the country will affect the best choice for a title. Further, the competing advertisements that appear on the same ‘internet page’ will impact the effectiveness of a specific title.

Although competing advertisements are not within an advertiser's control, their influence is very real. Therefore, as the competition changes advertisement schemes and placement position, there may well be a need to test again.

Since most factors involved in sales and marketing do influence each other, orthogonal arrays that require known interactions are not well suited to PPA applications. However, as will be explained hereinafter in greater detail, there are a few orthogonal arrays that exhibit unique characteristics where interactions are for the most part equally distributed through all the factors so they can be used effectively assuming real interactions are relatively modest and generalized. If however, real interactions are major and apply to specific factors, testing with these types of orthogonal arrays may produce erroneous optimization predictions. If conformation testing varies significantly from predicted values, further experiments may be considered to isolate major interactions.

Although there are conditions were advertising factors may exhibit major interactions, for most part, factor interaction for digital advertising is modest and generalized. Therefore orthogonal arrays that exhibit unique characteristics where interactions are for most part equally distributed through all the factors are reasonable choices for digital advertising experiments.

As mentioned earlier, orthogonal arrays are used in the development of a “design of experiments”. In this regard, orthogonal arrays may be employed in two common approaches: Inner arrays and Outer arrays.

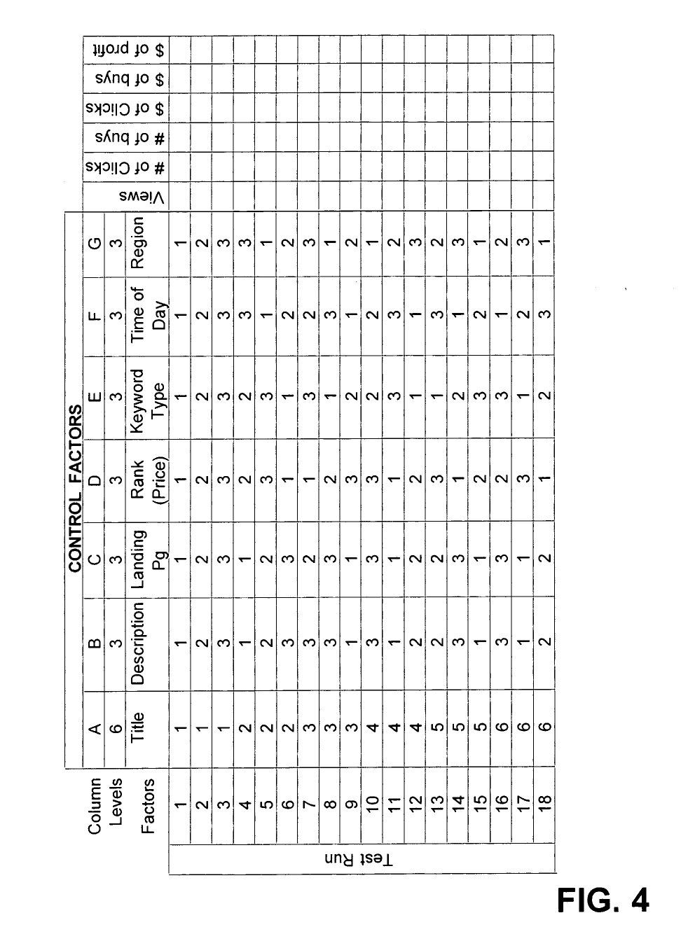

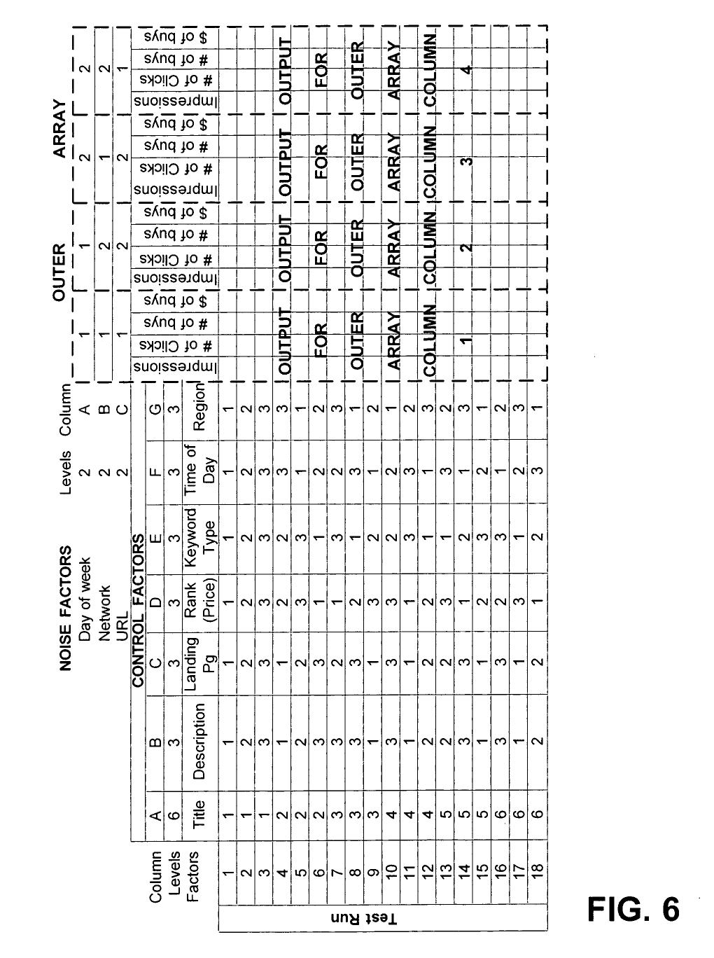

An Inner array consists of rows and columns. For example, with reference to FIG. 4, resulting observations are recorded to the right of the array. In FIG. 6, an outer array, shown in bold dashed outline introduces a second array and is used to isolate specific factors from those believed to contribute to the main effects. These outer array factors are typically considered “noise”, and may for example include: control factors that are not believed to contribute to the main effect; and factors that are measurable but not controllable. Lurking factors may be present and influential but are not measurable so they cannot be included in the design of the experiments.

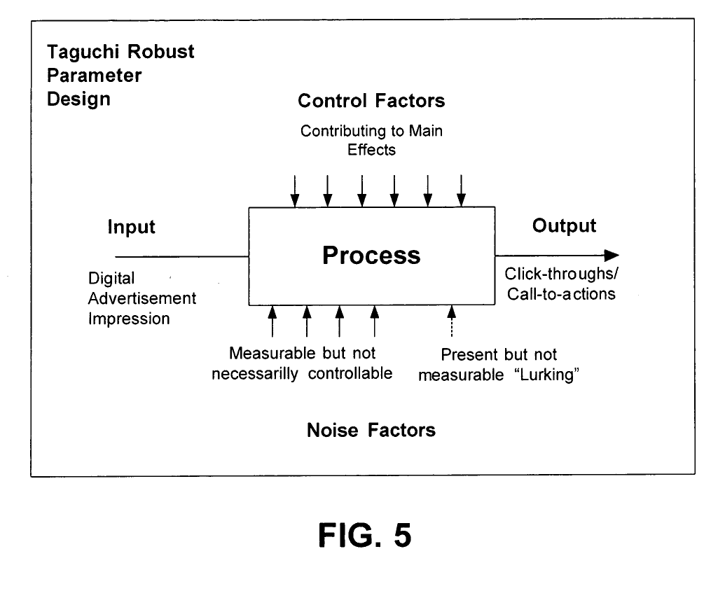

Test runs are conducted in accordance with the conditions of both Control Factors and Noise Factors as best seen in FIG. 5, which illustrates a Taguchi Robust Parameter Design as applied to the present invention.

Referring now to FIG. 6, four columns of output are shown. If the variation of each of the output columns is small, then the Noise Factors can be said to have little affect on the process. On the other hand, if there is significant variation between the column output data, at least one Noise Factor has significant influence. Further analysis or experiments may be necessary to isolate significant Noise Factors. For this reason, inclusion of outer arrays are said to provide “robustness” to the design of experiments.

The primary method of determining the influence of noise is called “Analysis of Variance” (ANOVA). Since partial factorial testing is only a sample of the full experiment, the analysis is the partial experiment must include an analysis of the confidence that can be placed in the results. Fortunately, there is a standard statistical technique called Analysis of Variance, which is routinely used to provide a measure of confidence. The technique does not directly analyze the data, but rather determines the variability (variance) of the data. Although test runs may be conducted in a single repetition, it is always better to perform several repetitions of the same test run so that output data variations may be analyzed. In this regard, the following are among the common approaches: mean analysis; standard deviation analysis; and signal to noise ratios. Confidence is measured from this variance.

Testing must be integrated into PPA delivery systems. It is important to note that all test variables and measurements are time sensitive. That is, all variables of a particular test run must be implemented at the same time. Likewise, measurements such as the number of impressions for a specific test run must be accurate.

Orthogonal Arrays referred to as L12, L18, and L36 and treatments (variations) of these arrays have been found to be the more efficient and effective inner arrays for PPA testing. In this regard, these array exhibit unique characteristics where interactions are, for the most part, equally distributed through all the variables. Outer arrays are optional when more robust testing is desired. These may be simple non-factorial conditions (e.g. weekday vs. weekend) or orthogonal arrays like L4 as shown in FIG. 6.

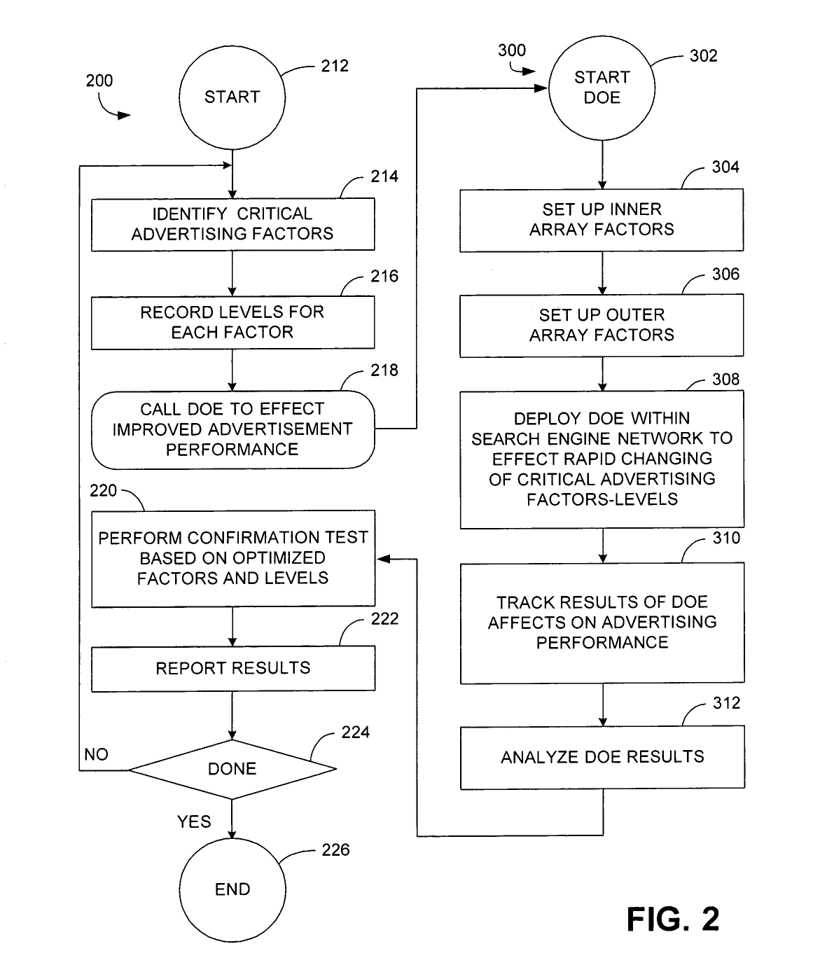

An illustrative case study will now be presented so readers will be better able to understand the preferred method 200 as illustrated in FIG. 2. In a first case study the optimization of several advertising factors for a Pay-Per-Click digital advertisement as shown on a well known search engine, will be considered for several keywords.

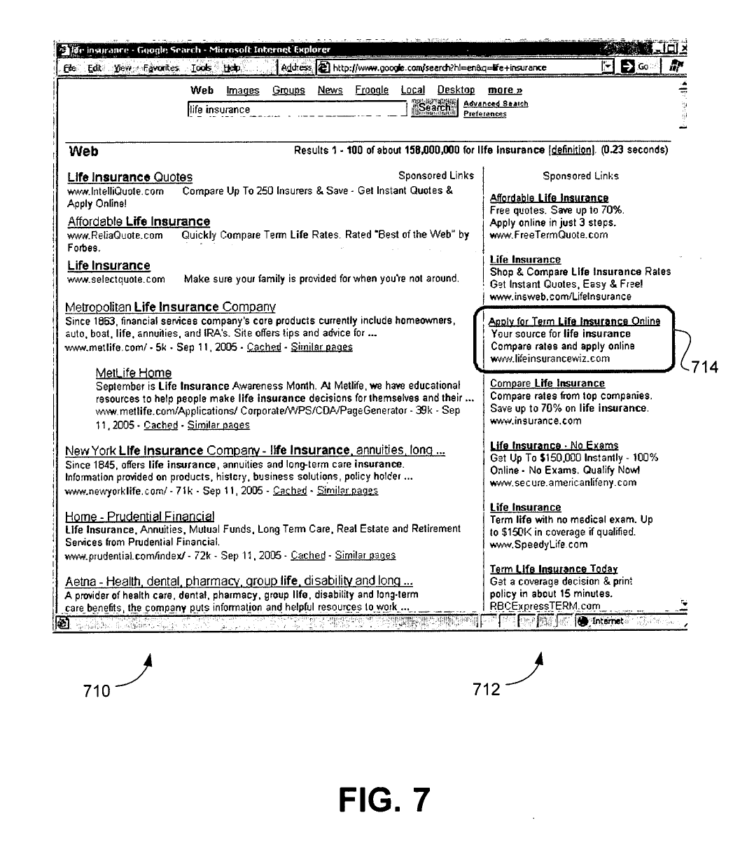

Referring now to FIG. 7, there is illustrated an example of a search engine result 710 showing “sponsored links” in a sponsored link column 712 as digital advertisement. The objective of the test is to isolate the most important advertising factors of the digital advertising process that positively influence a call-to-action. The call-to-action in this case study is the purchase of life insurance. The partial factorial test and subsequent analysis considers optimization of units and profit dollars.

A target advertisement 714 is shown among several other digital advertisements known as sponsored results displayed in the sponsored link column 712. The testing and analysis process 200 begins at a start step 212 and follows the steps that will now be described relative to FIG. 2.

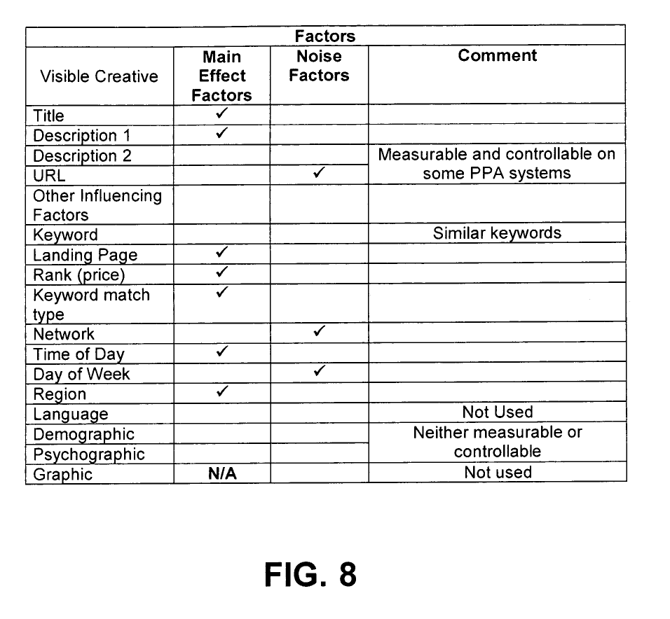

From the start step 212 the process continues to an identify step 214 whose function is to identify critical advertising factors. In this regard at the identify step 214, the process involves choosing the critical advertising factors for testing. It is not unusual that those experienced with digital advertising have a sense of which advertising factors have some influence and which advertising factors more likely than not will not have an influence. FIG. 8 illustrates the available factors, where the available factors have been chosen for test as primary or main effect factors.

With reference to FIG. 8 it should be noted that “landing page” is included as a test factor. Although a “landing page” could have many controllable factors worthy of a test by itself, this example considers the affects of three (3) different and complete “landing pages”. The affect of these different “landing pages” is included in the experiment but individual factors that make up the “landing page” are not considered.

It should also be noted that individual keywords could have a major affect on advertising performance and could be considered a primary factor. This case study example, considers several keywords, all of which have similar market meanings as illustrated by the following list: life insurance; term life insurance; whole life insurance; life insurance quotes; life insurance quote; term life insurance quote; term life insurance quotes. If the keywords chosen had not been so similar, there would be more justification for dedicating a primary factor for individual keywords (a level for each one).

Those factors that are not believed to have a major affect are considered noise. They are believed to have minor impact on advertising performance and may be included as part of an optional outer array. Or noise factors may be present but cannot be measured, and therefore, are not part of an outer array.

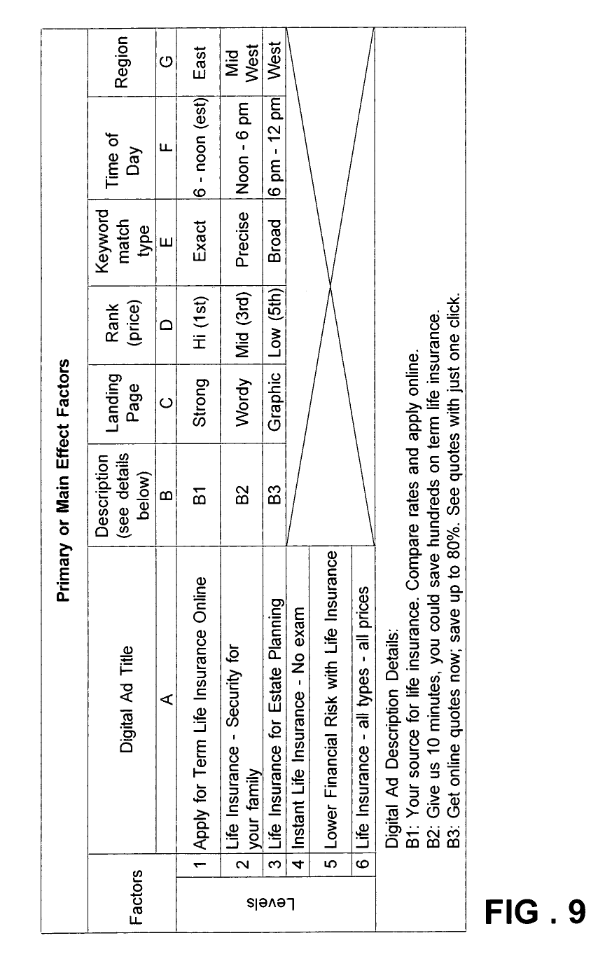

Once the critical advertising factors have been identified at the identify step 214, the process advances to record step 216. At the record step 216, the level of each advertising factor is recorded. The number of advertising factors and levels does influence the choice the orthogonal array with which to deploy the “design of experiment” (DOE). Since seven (7) advertising factors have been chosen for this example, orthogonal array allowing for one (1) six-level factor and six (6) three-level factors is chosen. FIG. 9 depicts a table of “Primary or Main Effect Factors” and covers the levels for each advertising factor considered. Note in FIG. 9, that each level should be distinctively different so as to produce a meaningful disparity among the results. For example, three distinctively different landing pages are considered. Each is very different in that the first (“strong”) has a very strong appeal. The second landing page is wordier, and the last is more graphic intensive. Without the distinctively different versions, test results may not show what kind of landing page produces better results.

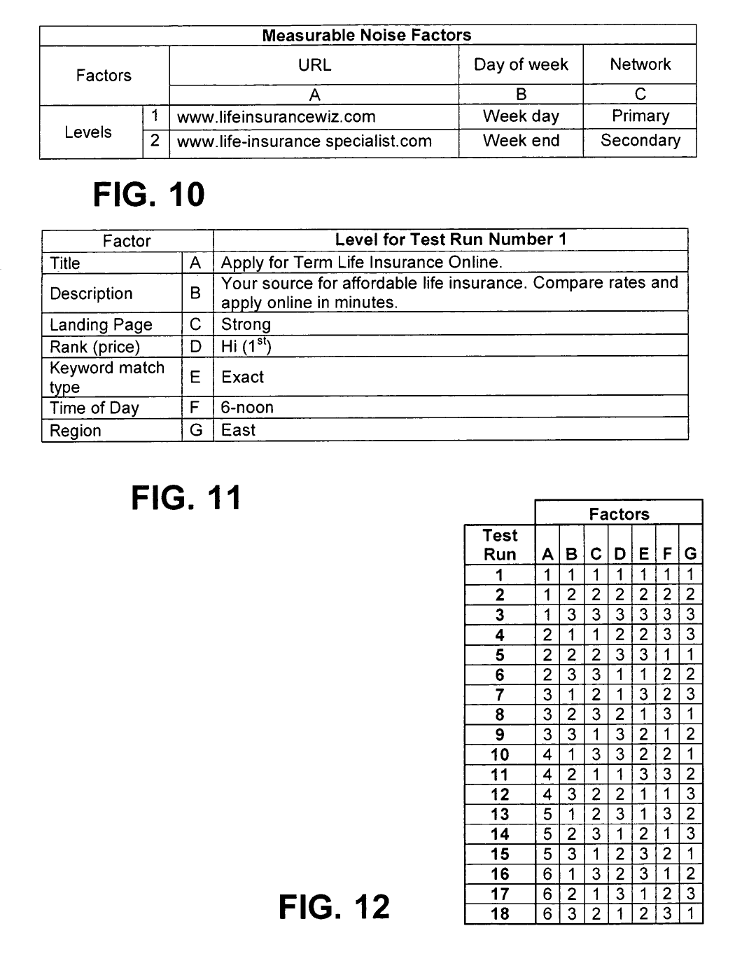

It should be noted that a full factorial test for this example would require 437 unique tests and each would need to be run many times to attain statistical significance. A partial factorial test for these conditions requires 18 unique tests. In order to isolate the influence or affects of measurable noise factors, the factors illustrated in FIG. 10 are considered for an outer array.

Once the levels for each of the factors have been recorded, the process continues to a call command 218 that calls the design of experiment to effect improved advertising performance. In this example, an orthogonal array (OA) well suited for one (1) six-level factor and six (6) three-level factors is a variant of the L18 array sometimes referred to as L18B.

The DOE advances from its start command at step 302 to a setup command 304, which causes the setup of inner array factors and levels. In this regard, referring to FIGS. 11-12, each of the 18 test runs (FIG. 12) contains a single level from each advertising factor. In the case of test run number 1, the factor levels illustrated in FIG. 11 are utilized. A design of experiments refers to the implementation of designated factor-levels for each test run.

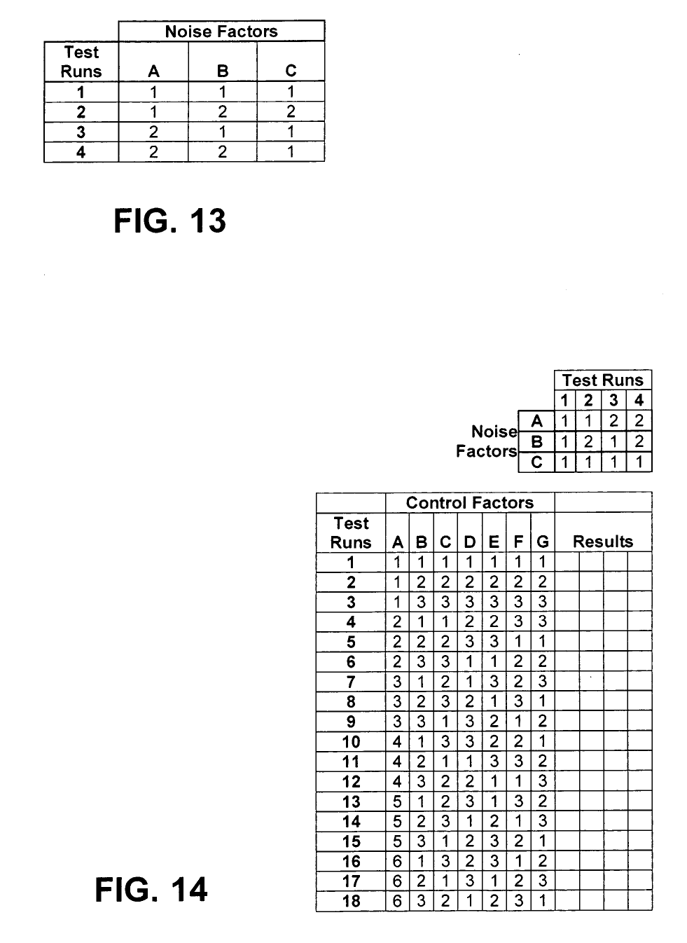

Next the process advances to another setup command 306 which set up the outer array factors and levels. In this regard, an outer array is added, but not required to complete the design of experiment. For example, a simple outer array may be added to distinguish day-of-week factors (weekdays versus weekends). A more complex outer array for example, could include additional factors such as: a URL, day-of-week, and network. Adding an outer array, such as illustrated in FIG. 13 requires that each of the 18 test runs of the inner array be run by the number of test runs in the outer array. In the present example, the DOE would require 18×4 or 72 test runs.

The completed design of experiment (inner and outer array) is represented by FIG. 14.

The process then proceeds to a deploy step 308 within a designated search engine network to effect rapid changing of the critical advertising factors-levels. In order to deploy a DOE with a “search engine advertising system” (SEAS), several advertisement factors-levels in accordance with the DOE must be adjusted and monitored. Such adjustment could be manually implemented through an existing SEAS interface, but such efforts would be time consuming and manually intensive. A much more practical approach is to employ a “DOE deployment engine” that automatically makes factor-level adjustments in accordance with the DOE.

A “DOE deployment engine” may be made part of the SEAS interface or operated outside the SEAS through the use of special communications protocols that directly affect the display of the digital advertisement. The latter method is commonly referred to as an Application Programming Interface (API).

Test runs may be conducted simultaneously if the variables and/or levels do not overlap with the same audience. For instance, test runs 1, 9, and 14 as previously illustrated, may be run at the same time since variable “G” (region) is different for each of these test runs. The ability to perform simultaneous test runs in this manner is a function of the SEAS capabilities.

Four sets of results (known as repetitions) are attained for each test run, one for each noise factor combination so as to produce sufficient data sets for analysis. In order to reduce the affects of uncontrolled or “Lurking” noise, test runs are randomized every thirty minutes.

Next at a tracking step 310, the process tracks results of the DOE affects on advertising performance as illustrated. That is, the following data was collected for each test run and repetition using analytics provided by the SEAS and click tracking software. In this regard, the following was provided by SEAS: the number of digital advertisement impressions; and the cost for digital advertising impressions. The click tracking software provided: the number of click-throughs, the number of call-to-actions, and the gross profits of call-to-actions, which could be net/gross sales or profit values. The experiment ran for the following key words: life insurance, term life insurance, whole life insurance, life insurance quotes, life insurance quote, term life insurance quote, and term life insurance quotes.

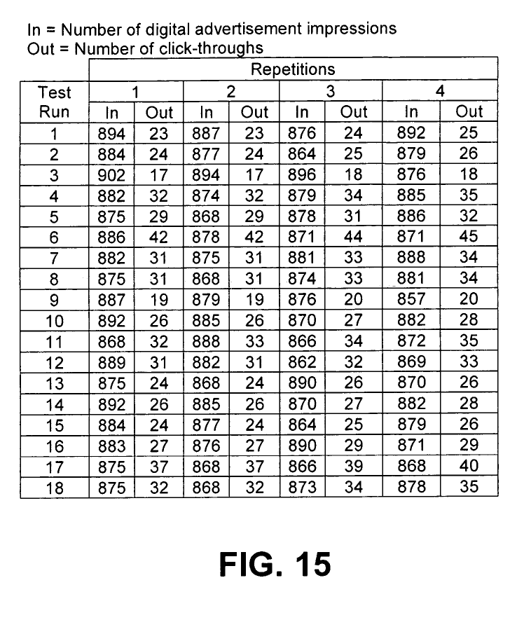

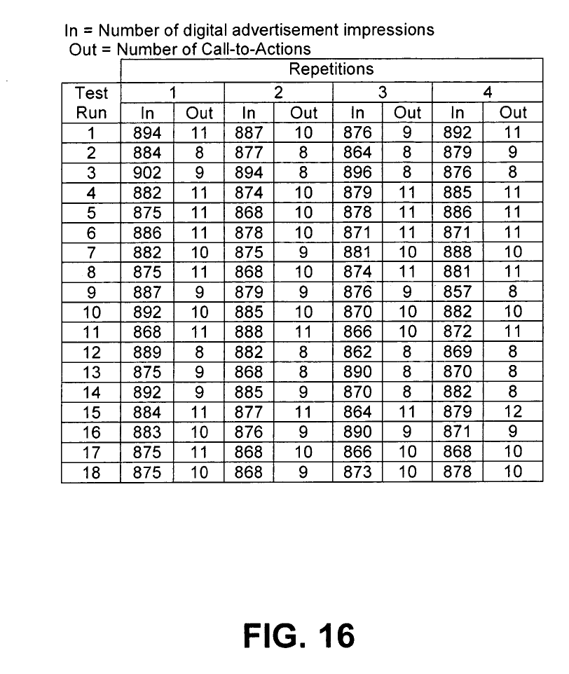

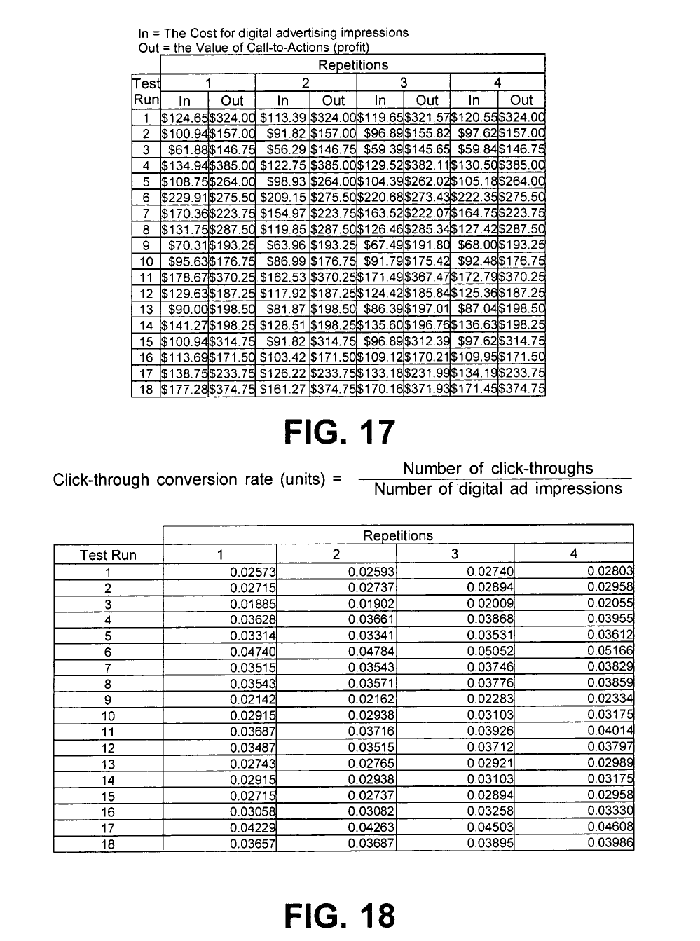

Factor F (time of day) was made relative to factor G (region), and where more than one time zone applied to a region, the time zone of the more populous area of the region applied. FIG. 15 summarizes the test run input and output values, where IN is equal to the number of digital advertisement impression and OUT is equal to the number of click-throughs. FIG. 16 summarizes the test run inputs and output values, where IN is equal to the number of digital advertisement impressions and OUT is equal to the number of call-to-actions. FIG. 17 summarizes the test run input and output values, where IN is equal to the cost for digital advertising impressions and OUT is equal to the value of call-to-actions (profits). Note that FIG. 15 represents test data to optimize click-through conversion rates, the first process of the sales funnel expressed in FIG. 3. FIGS. 16 and 17 represent tests data to optimize call-to-action ratios (units and dollars respectively), the entire process of the sales funnel expressed in FIG. 3. Analysis of these test data will permit comparing main effect factors and levels for different portions of the sales process. Available data does permit for analysis of the second portion of the sales process to isolate landing page factors that influence the likelihood of call-to-action but is not included in this example.

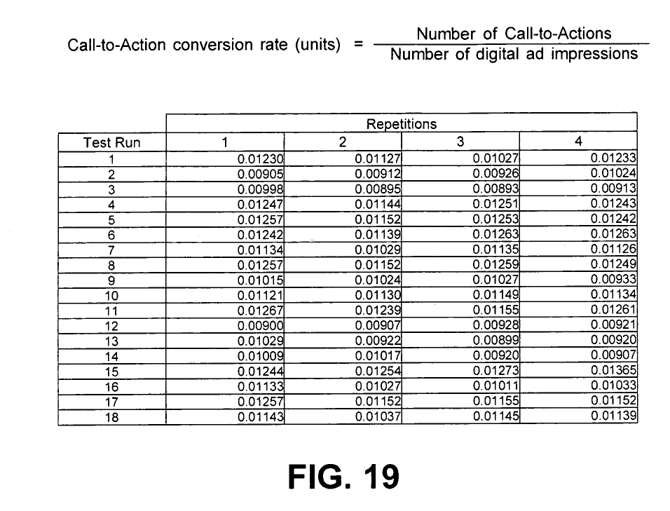

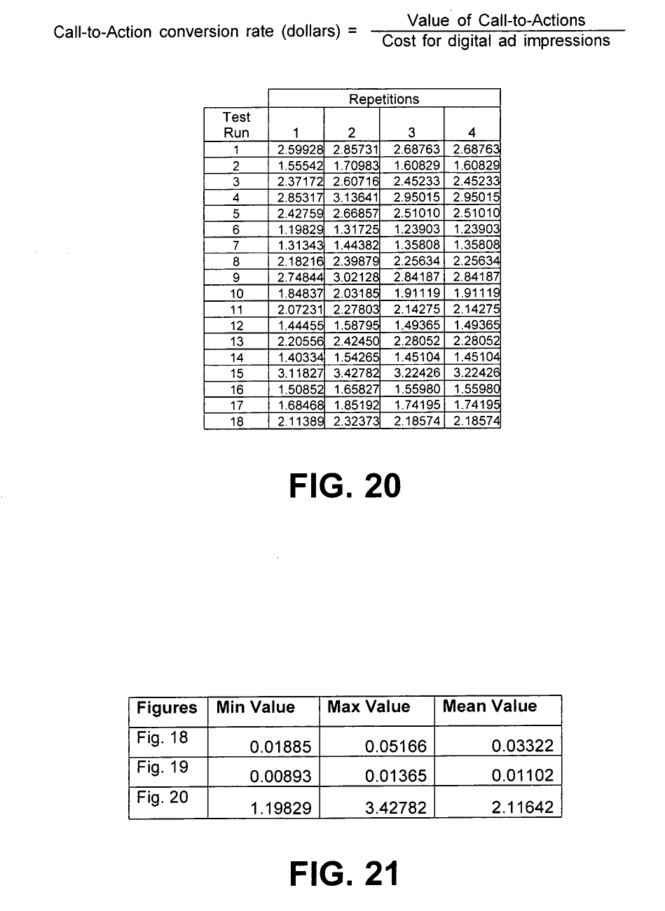

After tracking at step 310, the process continues to an analyze step 312, where the DOE results are analyzed. In this regard, in order to analyze the resulting data, the input and output values as illustrated in FIGS. 15-17, are converted to ratios as illustrated in FIGS. 18-20 using the following formula:
Click-through conversion rate (units)=number of click-throughs/number impressions
Call-to-action conversion rate (units)=number of call-to-actions/number of impressions
Call-to-action conversion rate (dollars)=value of call-to-actions/cost for impressions

When the analysis is completed with minimum, maximum and mean values being derived as illustrated in FIG. 21, the DOE returns to the main testing and analysis process 200 by advancing to a perform step 220.

Before discussing the perform step 220, it would be beneficial first to consider the analyze step 312 in greater detail. In this regard, there are numerous methods and commercially available analysis tools for analyzing the results of DOE. Most tools follow the same process:
1. Analyze mean, standard deviation and/or signal to noise ratios to determine which factors and levels contribute the greatest gains (“larger is better” analysis is applied to the present case study).
2. Pool results to discard the contribution of low contribution factors and subsequently adjusting the contributions of the remaining factors.
3. Perform ANOVA calculations to determine quality or statistical significance of results that may be influenced by noise factors and/or test run size. This step is often expressed in the form of a “confidence level and interval”.
4. Predict optimal performance based on the most influential factors-levels.

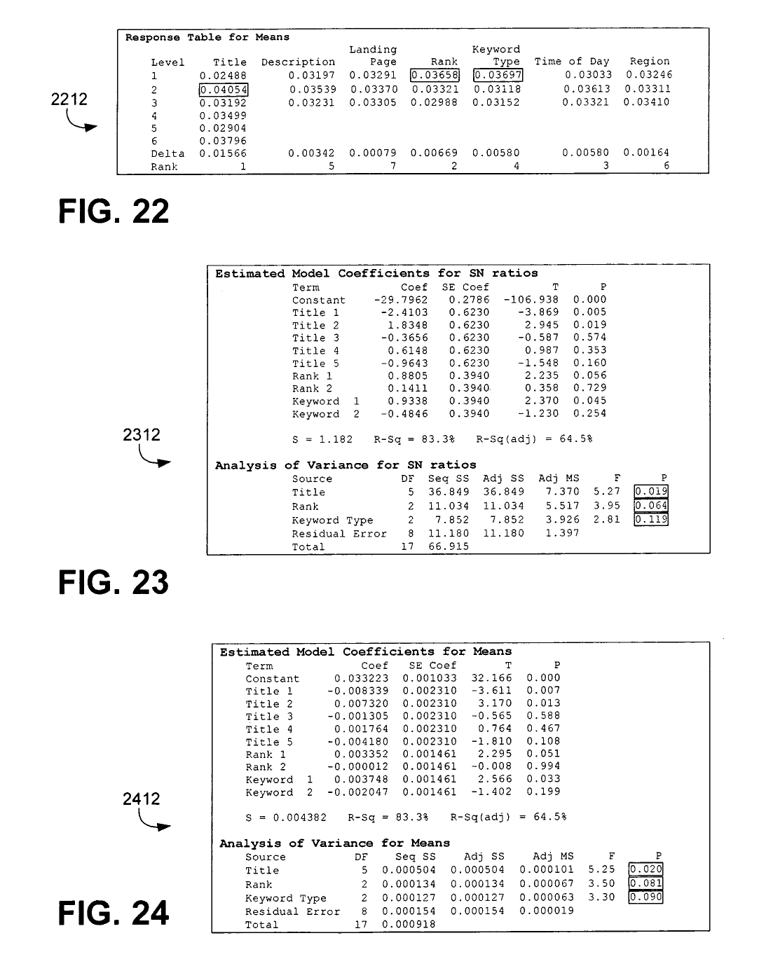

The following will demonstrate the analysis for the number of digital advertisement impressions versus the number of click-throughs. Considering now FIG. 22 a response table 2212 for means is illustrated wherein the response table 2212 shows that title, rank, and keyword types, have the highest values within each factor. Thus, they are the most influential factors. Pooling the remaining factors produce additional calculations. For example FIG. 23 illustrates a linear model analysis table 2312 of signal to noise ratios versus title, rank and keyword types. FIG. 24 illustrates another linear model analysis table 2412 of means versus title, rank and keyword types.

Referring now to FIGS. 23-24, low P values in the ANOVA calculations is indicative of high quality data. P values of less than 0.050 indicate better than a 95% confidence level where as a value of 0.100 indicates a 90% confidence level. Based on these P values, calculating estimating optimal factors/levels can produce estimates with good confidence and it can be said that noise factors had minimal influence.

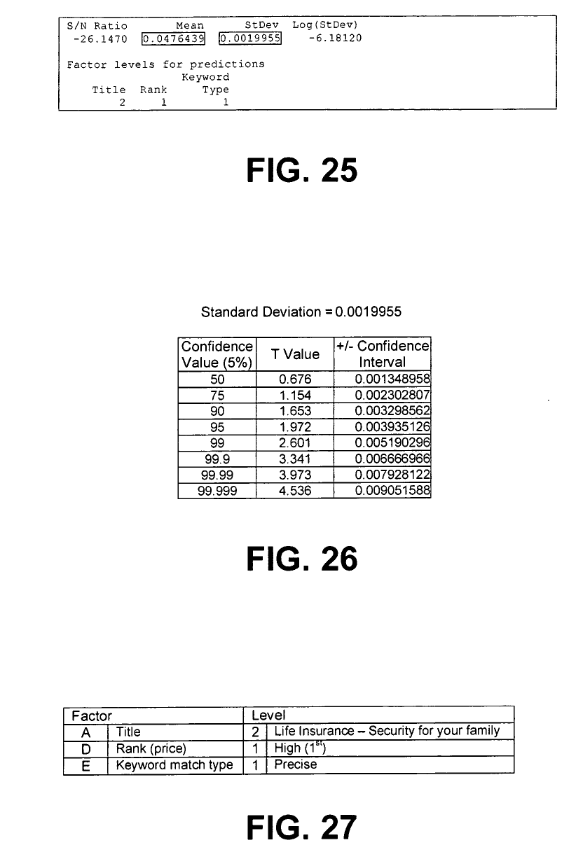

Referring now to FIG. 25, analysis predicts that an optimal click-through rate of 0.0476439. Assuming a normal distribution, a 95% confidence interval is computed as:
±1.96×St Dev=±0.0039,
Where standard deviation=0.0019955 (from FIG. 25)
   Other confidence intervals are computed in a similar manner for different confidence levels, assuming normal distribution. These results are illustrated in FIG. 26.

The most important or influential factor-levels as predicted for click-through conversion ratios are illustrates in FIG. 27. This predicted value is 43% greater than the mean (average) value for all the test runs. For example:
(0.04764 [from FIG. 25]/0.03322[from FIG. 21])−1=0.43

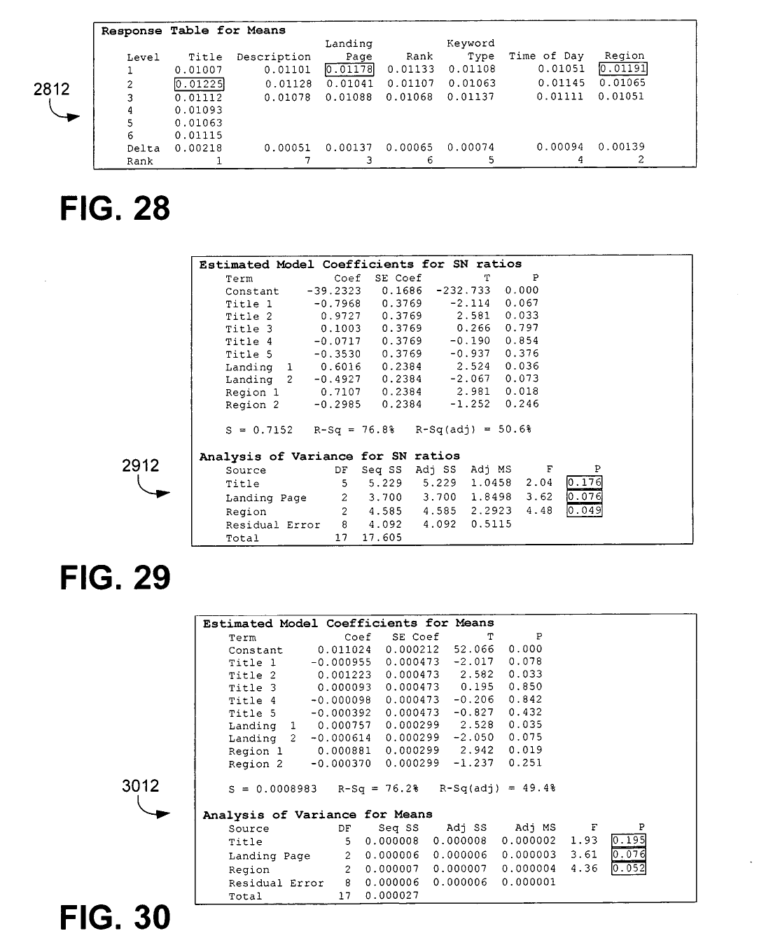

The following will demonstrate the analysis for the number of digital advertisement impressions versus the number of call-to-actions. Considering now FIG. 28 a response table 2812 for means is illustrated wherein the response table 2812 shows that title, landing page, and region, have the highest values within each factor. Thus, they are the most influential factors. Pooling the remaining factors produce additional calculations. For example FIG. 29 illustrates a linear model analysis table 2912 of signal to noise ratios versus title, landing page and region. FIG. 30 illustrates another linear model analysis table 3012 of means versus title, landing page, and region.

As before, a low P value in ANOVA calculations shown in FIGS. 29 and 30 is indicative of high quality data. In this case, values less than 0.050 indicate better than a 95% confidence level, where as a value of 0.100 indicates a 90% confidence level. Some of these P values, are indeed higher (not unusual for small ratios); however, all the P values are within 80% confidence levels.

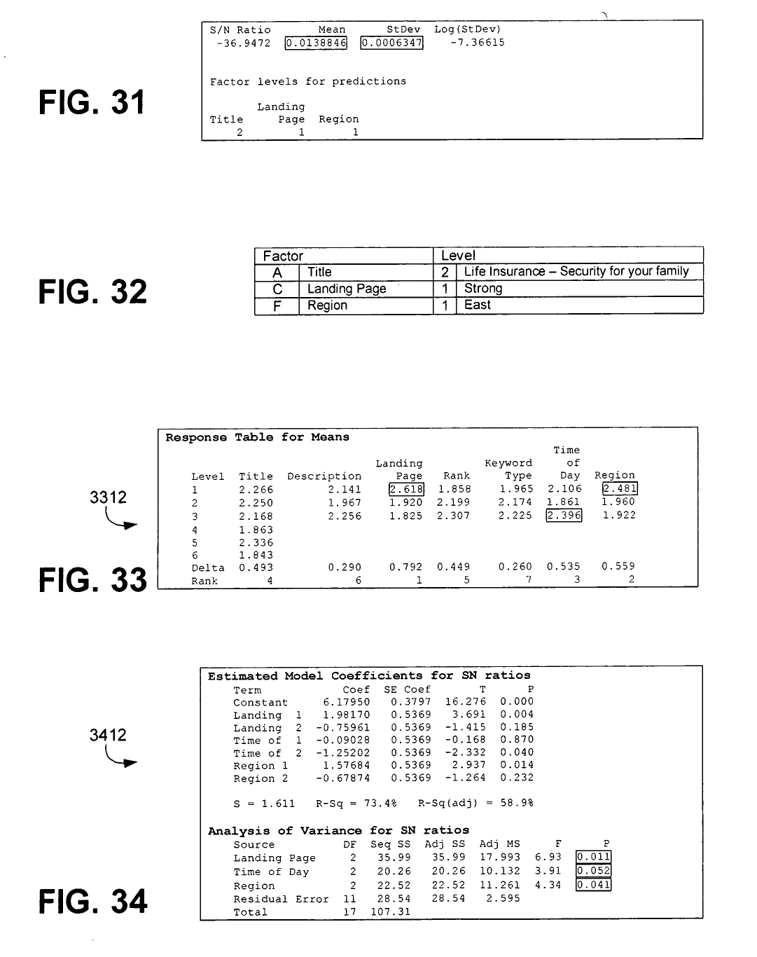

Referring now to FIG. 31, analysis predicts that the optimal conversion to a call-to-action is 0.01388. Assuming a normal distribution, 90% confidence interval is computed as:
±1.653×St Dev=0.001049
This predicted value is 26% greater than the mean (average) value for all test runs. FIG. 32 illustrates the predicted most influential factor-levels levels for call-to-action conversion rates (units).

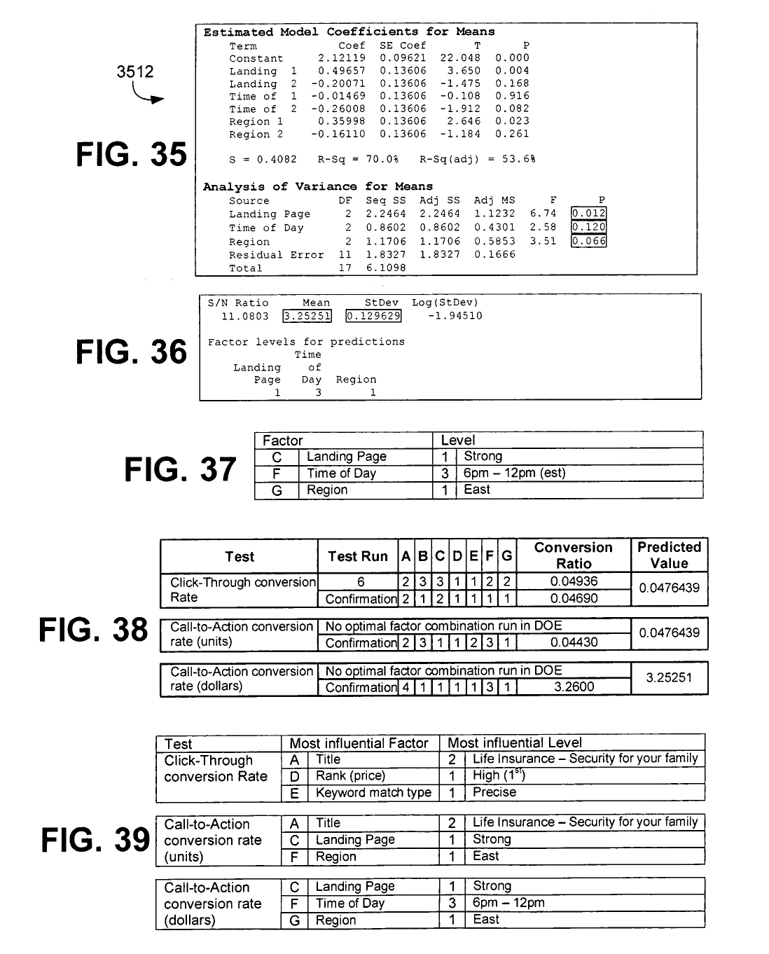

The following will demonstrate the analysis for the number of digital advertisement impressions versus the profit of call-to-actions. Considering now FIG. 33 a response table 3312 for means is illustrated wherein the response table 3312 shows that landing page, time of day and region, have the highest values within each factor. Thus, they are the most influential factors. Pooling the remaining factors produce additional calculations. For example FIG. 34 illustrates a linear model analysis table 3412 of signal to noise ratios versus landing page, time of day and region. FIG. 35 illustrates another linear model analysis table 3512 of means versus landing page, time of day and region.

Again, as mentioned before, a low P value in ANOVA calculations shown in FIGS. 34 and 35 is indicative of high quality data. In this case, values less than 0.050 indicate better than a 95% confidence level, where as a value of 0.100 indicates a 90% confidence level. Based on these P values, calculating estimating optimal factors/levels can produce estimates with good confidence.

Referring now to FIG. 36, the analysis predicts that the optimal conversion to a call-to-action is 3.25251. Assuming a normal distribution, 95% confidence interval is computed as:
±1.96×St Dev=±0.2541
This predicted value is 53% greater than the mean (average) value for all test runs. FIG. 37 illustrates the predicted most influential factor-levels.

Considering now the testing and analysis process 200 in relation to the perform step 220, confirmation test based on optimized factors and levels. In this regard, the case study test develops a DOE using an L18B orthogonal array that exhibits unique characteristics where interactions are, for the most part, equally distributed through all the variables. Such unique characteristics preclude the ability to analyze factor interactions. Therefore, in such situations, it is highly recommended to perform a confirmation test based on the optimized factors and levels to validate the optimization predictions.

If after running a test with the optimized factors and levels, the results are substantially different, it can be assumed that major factors do exist and/or “lurking noise” factors are present. In this case, more testing is recommended to isolate these conditions.

During the first test for click-through-conversion, test run #6 coincidentally included the optimized factors and levels as best seen in Table II.

TABLE II
Test Run Number 6

| Test Run | A | B | C | D | E | F | G |
|---|---|---|---|---|---|---|---|
| 6 | 2 | 3 | 3 | 1 | 1 | 2 | 2 |

The test run illustrated in table III produces a mean conversion ratio of 0.04936, which is very close to the predicted optimal value of 0.0476439. A confirmation test using different levels for B, C, F and G should be conducted as illustrated in Table III to be certain there is no significant interaction with optimal factors.

TABLE III
Confirmation Run

| | | | | | | | | Conversion |
|---|---|---|---|---|---|---|---|---|
| Test Run | A | B | C | D | E | F | G | Ratio |
| Confirmation | 2 | 1 | 2 | 1 | 1 | 1 | 1 | 0.0469 |

A summary of tests with confirmation test runs for each test is illustrated in FIG. 38. The results of confirmation testing strongly supports the validity of the test assumptions and design.

After the confirmation testing is completed, the process advances to a report step 222 which cause various reports to be generated. More particularly, based on the design of experiments and subsequent analysis of variation (ANOVA) for the 3 different partial factorial tests previously illustrated, the observations as shown in FIG. 39 can be made. In summary then, the test showed that optimal factors are somewhat different for click-through versus call-to-action conversion rates. If testing were to have considered only click-through conversion rates, the entire call-to-action process would not have been considered for optimization.

It is also significant to note that optimal factors for call-to-action units are not the same as for dollars. Therefore, if dollars (profits) are to be optimized, optimal factors in the last test should be utilized. If the business objective is to optimize unit sales, optimal factors from the second test should be utilized.

After the results are reported the process advances to a decision step 224, where a determination is made relative to whether further testing should be conducted. If so, the process returns to step 214 and proceeds as previously described. If no further testing is to be conducted the process advances to an end step 226 that terminates process 200.

Considering now the pay-for-performance system 10 in greater detail with reference to FIG. 1, the pay-for-performance system 10 generally includes a computer 12 having a memory unit 18. The computer 12 is coupled to a display unit 14 for enabling a user to visually see data entered into the memory unit 18 as well as design of experiment results that will be described hereinafter in greater detail.

The pay-for-performance system 10 also includes a keyboard 16 and disc drive 20 that facilitate the entry of data and programs into the memory unit 18. For example, instead of having the method 200 resident within the memory unit 18 as a client based program, a web application program 22 that resides on a remote server could provide access to a user account on the Internet which allows the user to run the method 200 through a user provided Internet browser.

Considering now the preferred method 200 in greater detail with reference to FIG. 2, the preferred method 200 as will be explained hereinafter in greater detail, identifies critical advertising factors associated with a target advertisement; continues on an on-going basis, in real time, an assessment of the critical advertising factors in improving the effectiveness of the target advertisement; predicts improvements in the effectiveness of the target advertisement due to certain individual ones of the critical advertising factors changing in real time; and implements into a pay-for-performance advertising network, changes in those critical advertising factors that will improve the effectiveness of the target advertisement. In short then, the preferred method 200 provides a scientific method of testing pay-per-performance advertisements for context sensitive Internet networks. The preferred method 200 as will be explained hereinafter in greater detail, applies fractional factorial “design of experiment” methods to quickly assess the influence of different advertising factors. In this regard, the invention is applied to context sensitive Internet networks commonly referred to as “search engines” and their advertising networks.

Referring now to FIG. 2, the preferred method 200 begins at a start command 212 and proceeds to an input command 214 where a user, using the keyboard 16 or any other convenient input device, enters into the system 10 a listing of those critical advertising factors associated with advertisements that are similar to a target advertisement whose performance is to be improved.

Next, a record command 216 causes the critical factors that have been entered to be recorded into a storage device, such as a memory unit 18 forming part of the computer system 10.

Once the basic information has been entered and stored, the process goes to a call command 218 which calls a DOE subroutine 300 that will be described hereinafter in greater detail. It will suffice for the moment to mention that the DOE subroutine 300 is a design of experiments subroutine that uses orthogonal arrays for partial factorial testing.

After the DOE subroutine 300 has been executed and data collected by the computer 12, the process advances to a perform confirmation test step 220 that causes the computer 12 to perform a confirmation test based on optimized factors and levels. The success of the target advertisement is then reported to a user or client at a report step 222.

The process 200 then continues to a decision step 224, where a determination is made whether or not any further improvements are needed in the target advertisement. If no further improvements are needed, the process advances to an end command 226 which end the process. On the other hand, if further improvements are needed, the process returns to the identify step 214 and proceeds as previously described.

Considering now the DOE subroutine 300 in greater detail with reference to FIG. 2, the DOE subroutine 300 begins at a start command 302 which is initiated by the call command 218. From the start command 302, the DOE subroutine advances to a set up command 304 which causes the set up of the inner array choices.

The subroutine then proceeds to another set up command 306, which causes the set up of the outer array choices. Next, the subroutine advances to a deploy command 308 that causes the design of experiments to be deployed through one or more search engines in a pay-for-performance advertising network utilizing an application program interface or direct database access. In this regard, such deployment effects rapid changing of critical advertising factors for the target advertisement.

After the design of experiments is deployed, the program goes to a tracking step 310 that causes the results of the design of experiments to be tracked. In other words, the effect of changing one or more of the critical advertising factors is recorded.

Next, the program causes a calculation of the design of experiments to be made at a analyze step 312. Upon completion of the calculation step 312, the DOE subroutine is completed and the process goes to the evaluation step 220 described previously and continues in the same manner as described earlier.

In the preferred embodiment, the computer readable code has been described as being encoded on a disc 70 that can be entered into the computer memory 18 by the disc drive 20, which reads and transfers the code under computer control. However, it is contemplated that the code could be entered remotely via an Internet web application 22 from another computer through a high speed cable or satellite connection, or directly from or any other input device that is capable of communication with the computer 12. Therefore, while a particular embodiment of the present invention has been disclosed, it is to be understood that various different modifications are possible and are contemplated within the true spirit and scope of the appended claims. There is no intention, therefore, of limitations to the exact abstract or disclosure herein presented.

We claim:

1. A method of improving the performance of a target advertisement in a pay-for-performance advertising network, comprising:
identifying a plurality of critical advertising factors that facilitate improved advertising performance for advertisements similar to the target advertisement in the pay-for-performance advertising network; and
testing in real time by utilization of the influence of individual ones of said plurality of critical advertising factors that facilitate improved advertising performance in the pay-for-performance advertising network by application of a fractional factorial design of experiments.

2. The method according to claim 1, wherein each individual one of said plurality of critical advertising factors has at least one level.

3. The method according to claim 1, wherein each individual one of said plurality of critical advertising factors has N levels, where N is equal to or greater than one.

4. The method according to claim 1, further comprising:
implementing identified individual ones of said plurality of critical advertising factors into the pay-for-performance advertising network when there is a test-verified improvement provide by the identified individual critical advertising factors.

5. The method according to claim 4, further comprising:
predicting which individual ones of said plurality of critical advertising factors will improve advertising performance in the pay-for-performance advertising network; and
updating in real time said plurality of critical advertising factors.

6. An apparatus for improving the performance of a target advertisement in a pay-for-performance advertising network, comprising:
a design of experiments processor which implements the steps of:
identifying a plurality of critical advertising factors that facilitate improved advertising performance for advertisements similar to the target advertisement in the pay-for-performance advertising network;
testing in real time by utilization of the influence of individual ones of said plurality of critical advertising factors that facilitate improved advertising performance in the pay-for-performance advertising network by application of a fractional factorial design;
implementing identified individual ones of said plurality of critical advertising factors into the pay-for-performance advertising network;
predicting which individual ones of said plurality of critical advertising factors will improve advertising performance in the pay-for-performance advertising network; and
updating in real time said plurality of critical advertising factors.

7. A computer program product, comprising:
a computer usable medium having a computer readable program embodied in said medium for causing an improvement process to be executed by a computer system, said computer program product including:
computer readable code for causing said computer system to identify a plurality of critical advertising factors that facilitate improved advertising performance for advertisements similar to the target advertisement in the pay-for-performance advertising network; and
computer readable code for causing said computer system to test in real time by utilization of the influence of individual ones of said plurality of critical advertising factors by application of a fractional factorial design.

8. A method of improving the performance of a target advertisement in a pay-for-performance advertising network, comprising:
testing the influence of individual ones of a plurality of critical advertising factors on the success of the target advertisement by applying factional factorial design; and
implementing those individual ones of said plurality of critical advertising factors improving the success of the target advertisement into a pay-for-result advertising network.

9. The method according to claim 8, further comprising:
predicting which individual ones of said plurality of critical advertising factors appear to improve the success of the target advertisement in a pay-for-results advertising network in response to said step of testing; and
updating said plurality of critical advertising factors with predicted individual ones of said plurality of critical advertising factors that appear to improve the success of the target advertisement in a pay-for-results advertising network.
offering “Pay-Per-Action” advertising models. This type of advertising model will be called herein after a PPA model.

10. A method of improving landing page performance, comprising:
identifying critical landing page characteristics affecting pay-per-action performance in a pay-per-action model;
deploying design of experiment within a search engine network to effect rapid changing of those critical landing page performance characteristics affecting pay-per-action performance in said pay-per-performance model; and
analyzing design of experiment results to confirm optimization of factors and levels for improved landing page performance.

11. The method of improving landing page performance according to claim 10, further comprising:
performing at least one confirmation test based on said step of analyzing.

12. The method of improving landing page performance according to claim 11, further comprising:
reporting results to determine whether further testing and analyzing is required to improve landing page performance.

13. The method of improving landing page performance according to claim 10, wherein said step of identifying includes:
identifying page landing characteristics.

14. The method of improving landing page performance according to claim 10, wherein said step of identifying includes:
identifying critical advertising characteristics.

15. An apparatus for improving landing page performance, comprising:
means for identifying critical landing page characteristics affecting pay-per-action performance in a pay-per-action model;
means for deploying design of experiment within a search engine network to effect rapid changing of those critical landing page performance characteristics affecting pay-per-action performance in said pay-per-performance model; and
means for analyzing design of experiment results to predict optimization of factors and levels for improved landing page performance.

16. The apparatus for improving landing page performance according to claim 15, further comprising:
means for analyzing confirmation test results to confirm optimization of factors and levels for improved landing page performance.

17. A computer program product for improving landing page performance, comprising:
a computer usable medium having computer readable program code means embodied in said medium for causing landing page performance to be improved, said computer program product having:
computer readable program code means for causing a computer to facilitate the identification of critical landing page characteristics affecting pay-per-action performance in a pay-per-action model;
computer readable program code means for causing a computer to facilitate design of experiment deployment within a search engine network to effect rapid changing of those critical landing page performance characteristics affecting pay-per-action performance in said pay-per-performance model; and
computer readable program code means to facilitate the analysis of the design of experiment results to predict optimization of factors and levels for improved landing page performance.

18. The computer program product for improving landing page performance, according to claim 17, further comprising:
computer readable program code means to facilitate the analysis of confirmation test results to confirm optimization of factors and levels for improved landing page performance.
